(19) United States
(12) Patent Application Publication
(10) Pub. No.: US 2019/0284866 A1
(43) Pub. Date: Sep. 19, 2019

(54) Knurling Apparatus and Methods for Architectural Assemblies

(71) Applicant: Arconic Inc., Pittsburgh, PA (US)

(72) Inventors: Martin C. Marinack, JR., Pittsburgh, PA (US); Mark Crowley, Pittsburgh, PA (US); Sneh Kumar, Monroeville, PA (US); Michael Chilko, New Kensington, PA (US); Bill Hooper, Lawrenceville, GA (US); Ion-Horatiu Barbulescu, Atlanta, GA (US); Deryck Serrano, Greensburg, PA (US)

(73) Assignee: Arconic Inc., Pittsburgh, PA (US)

(21) Appl. No.: 16/332,000

(22) PCT Filed: Dec. 8, 2017
(86) PCT No.: PCT/US2017/065267

§ 371 Date: Mar. 11, 2019

Related U.S. Application Data
(60) Provisional application No. 62/432,015, filed on Dec. 9, 2016.

(51) Int. Cl. E06B 3/263; E06B 3/26; B21D 39/02

(52) U.S. Cl. CPC E06B 3/26305; E06B 3/26; E06B 2003/26314; B21D 39/02; E06B 3/26303

(57) ABSTRACT

A composite architectural frame section with subcomponents that meet functional, strength and thermal isolation requirements is assembled using knurling and crimping operations as joining procedures. When properly designed the knurling and subcomponent geometries with proper crimping operations result in an optimal shearing strength between critical subcomponents, thus maximizing the structural performance aspect of the frame section. Various embodiments of this design address requirements for subcomponent features such as: hammer and anvil tips, orientation of knurled and crimped surfaces, design of the knurling wheel components, and the introduction of alternate surface topographies to additional regions of these contacting frame subcomponents. These embodiments serve to maximize the portion of available interface contact surfaces and their friction that can bear shearing forces and, thus, add to the overall shear strength of the frame section.

### CROSS-REFERENCE TO RELATED APPLICATIONS

This application claims the benefit of U.S. Provisional Application No. 62/432,015, filed Dec. 9, 2016, entitled, Knurling Apparatus And Methods For Architectural Assemblies, which incorporated by reference in its entirety herein.

### FIELD

The present invention relates to architectural products, manufacturing apparatus, and methods for producing same, and more particularly, to composite products such as windows or doors that utilize at least one crimped conjunction of a first material, such as a metal extrusion and a second material, such as a polymer extrusion and methods and apparatus for making same.

### BACKGROUND

Architectural products, such as windows and doors are known which use composite elements, e.g., for window frames or sashes. The composite elements utilize an interior metal extrusion and an exterior metal extrusion held together by one or more plastic extrusions. The plastic extrusions make the mechanical connection between the inside and outside metal extrusions while providing a thermal barrier to reduce thermal transfer between the metal extrusions and are often called a “thermal break.” The plastic and metal extrusions are typically attached by inserting a portion of the plastic extrusion(s), i.e., a bead extending along an edge of the plastic extrusion, into a recess/slot in the metal extrusion and the recess in the metal extrusion is then crimped to grasp and hold the plastic bead in the slot. To increase the integrity of the plastic-metal conjunction, the metal extrusion may be knurled before crimping to produce a stronger interface.

### SUMMARY

The present disclosure relates to a composite member, having: an interior metal extrusion with a first recess therein extending along at least a portion of a length thereof; an exterior metal extrusion with a second recess therein extending along at least a portion of a length thereof; a thermal break with a thermal conductivity lower than a thermal conductivity of the interior metal extrusion and the exterior metal extrusion inserted there between and connected thereto; the thermal break having a plurality of beads extending along at least a portion of a length thereof, a first bead of the plurality of beads extending into the first recess and a second bead of the plurality of beads extending into the second recess, the interior and the exterior extrusions crimped proximate the first recess and the second recess, respectively, to hold the first bead and the second bead therein, respectively, the first recess and the second recess being knurled therein along at least a portion of a length thereof in a knurl pattern of peaks and valleys having a wavelength<0.040 inches, the peaks impressing at least partially into the first bead and the second bead.

In another embodiment, the first recess and the second recess each have a hammer portion and an anvil portion extending away from a back wall and a pre-crimped state with a first spacing between the hammer portion and the anvil portion, and a post-crimped state with a second spacing less than a width of the first spacing, the hammer portion of each of the first recess and the second recess moving proximate to the anvil portion when transitioning from the pre-crimped state to the post-crimped state and moving through a transition angle, the anvil portion remaining stationary relative to the hammer portion, the knurling pattern applied to a surface of the hammer at a first orientation relative to the back wall when in the pre-crimped state, such that the knurling pattern on the hammer portions of the first recess and second recess, respectively, contact the first bead and the second bead, respectively, in the post-crimped state after moving through the transition angle.

In another embodiment, the knurling pattern is applied to the anvil portions at a second orientation such that the knurling pattern on the anvil contacts the first bead and the second bead, respectively, in the post-crimped state after remaining stationary while the hammer portion moved through the transition angle.

In another embodiment, the first orientation and the second orientation are different.

In another embodiment, the first orientation and the second orientation are each 75° relative to the back wall.

In another embodiment, the first orientation is 75° relative to the back wall and the second orientation is 90° relative to the back wall.

In another embodiment, the wavelength is between 0.020 and 0.040 inches.

In another embodiment, the wavelength is 0.028 inches.

In another embodiment, an entire impression length (LK) of the peaks of the knurled pattern of the hammer contacts the bead in which it is impressed when in the post-crimped position.

In another embodiment, a portion of an impression length (LK) of the peaks of the knurled pattern of the hammer that contacts the bead in which it is impressed when in the post-crimped position exceeds a portion of the impression length (LK) that does not contact the bead in which it is impressed.

In another embodiment, a coefficient of friction between the first extrusion and the thermal break is≥0.23.

In another embodiment, a length of 4 inches of the composite member can withstand a shear load>1000 lbs.

In another embodiment, the back wall has a surface roughness and the thermal break in the post-crimped state engages the back wall.

In another embodiment, a method for knurling a recess of a metal extrusion defined by a hammer portion and an anvil portion extending from a back wall, includes the steps of: providing a knurling wheel with a knurl pattern of repeating peaks and valleys on a surface thereof proximate a periphery of the knurling wheel, the wavelength between peaks being<0.040 inches; pressing the knurling wheel against at least one of the hammer portion or the anvil portion and impressing a knurling pattern therein.

In another embodiment, further including pressing the knurling wheel against both the hammer portion and the anvil portion to impress a knurling pattern therein.

In another embodiment, the knurling wheel is held at a selected angle relative to the back wall of the metal extrusion during the step of pressing.

In another embodiment, the knurling wheel is held at a first selected angle relative to the back wall when pressing the knurling pattern against the hammer portion and at a second angle relative to the back wall when pressing the knurling pattern against the anvil portion.

In another embodiment, the knurling pattern is pressed against the hammer portion and the anvil portion simultaneously by different faces of the knurling wheel.

In another embodiment, the knurling wheel is pressed against the hammer portion of the metal extrusion at the first angle in a separate step from the pressing of the knurling wheel against the anvil at the second angle or by another knurling wheel.

In another embodiment, a knurling wheel, has a knurling surface disposed proximate a periphery of the wheel with a knurl pattern of repeating peaks and valleys on a surface thereof proximate a periphery of the wheel, the wavelength between peaks being<0.040 inches.

In another embodiment, the knurling surface is at an angle of 15° relative to a radius of the knurling wheel.

In another embodiment, the knurling surface is a first knurling surface and wherein the knurling wheel has a second knurling surface disposed on an opposite side thereof relative to the first knurling surface.

In another embodiment, the first knurling surface and the second knurling surface are disposed at different angles relative to the radius.

In another embodiment, the first knurling surface is at an angle greater than the second knurling surface.

In another embodiment, the second knurling surface is parallel to the radius.

In another embodiment, the knurling wheel is monolithic.

In another embodiment, the knurling wheel has a plurality of subcomponents, each approximating a solid of rotation.

In another embodiment, the plurality of subcomponents are provided in a set permitting selective assembly of different sub-components from the set resulting in composite knurling wheels having different dimensions.

In another embodiment, the knurling wheel is made by additive manufacturing.

In another embodiment, a portion of the knurling surface is curved.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is a perspective review of a composite member in accordance with an exemplary embodiment of the present disclosure.

FIG. 2 is an enlarged side view of a fragment of a composite member similar to that of FIG. 1.

FIG. 3 is an enlarged fragment of a composite member similar to that of FIG. 2, prior to crimping, as analyzed by finite element analysis.

FIG. 4 is the enlarged fragment of the composite member of FIG. 3 after crimping, as analyzed by finite element analysis.

FIG. 5 is a perspective view of a knurling apparatus knurling a metal extrusion.

FIG. 6 is a perspective view of a knurling wheel in accordance with an exemplary embodiment of the present disclosure.

FIG. 7 is an enlarged perspective view of a fragment of the knurling wheel of FIG. 6.

FIG. 8 is a top view of the knurling wheel of FIGS. 6 and 7.

FIG. 9 is an enlarged view of a segment of the knurling wheel of FIG. 8.

FIG. 10 is a side view of a knurling wheel in accordance with an alternative embodiment of the present disclosure.

FIG. 11 is a diagram of contact made between a knurled hammer tip portion of a slot in an extrusion and a thermal break at the interface thereof, after crimping.

FIG. 12 is a diagram of an interface between a knurled hammer tip and a thermal break after crimping, at a perspective 90 degrees offset from that of FIG. 11 and subjected to an applied shear force.

FIG. 13 is a diagram of a knurling wheel imparting a knurling pattern to an extrusion.

FIG. 14 is a diagram of opposed knurled hammer and anvil tips of an extrusion knurled in accordance with a process as depicted in FIG. 13, prior to crimping.

FIG. 15 is a diagram of an interface between a knurled hammer tip of an extrusion knurled in accordance with a process as depicted in FIG. 13 and a thermal break, after crimping.

FIG. 16 is a diagram of an interface between a knurled anvil tip of an extrusion, knurled in accordance with a process as depicted in FIG. 13 and a thermal break, after crimping.

FIG. 17 is a diagram of a knurling wheel imparting a knurling pattern to an extrusion in accordance with an embodiment of the present disclosure.

FIG. 18 a diagram of an interface between a knurled anvil tip of an extrusion knurled in accordance with a process and apparatus as depicted in FIG. 17 and a thermal break, after crimping.

FIG. 19 is a graph of shear failure load vs. knurling wavelength as analyzed by finite-element analysis.

FIG. 20 is a graphical representation of a finite-element analysis of an interface of a knurled extrusion and a polymer thermal break under shear loading.

FIG. 21 is a histogram of experimental frame shear strength associated with knurling with two types of knurling wheels.

FIG. 22 is an enlarged fragment of a composite member similar to that of FIG. 2, prior to crimping.

FIG. 23A is a side view of a composite member.

FIG. 23B is an enlarged fragment of the composite member of FIG. 23A, prior to crimping, being roughened by an electric discharge device in accordance with another embodiment of the present disclosure.

FIG. 23C is a diagrammatic depiction of a roughening device and method for roughening a pair of slots in a metal extrusion.

FIG. 24 is a diagram of a knurling wheel imparting a knurling pattern to an extrusion in accordance with an embodiment of the present disclosure.

### DETAILED DESCRIPTION OF EXEMPLARY EMBODIMENTS

Aspects of the present disclosure relate to knurling wheels and methods of use thereof at various angles for knurling extrusions. The knurling wheels may be configured and/or positioned to improve and/or optimize knurling and the bite of a knurled extrusion into a thermal break. The knurling wheel(s) may have a knurling tooth/groove pattern with a reduced wavelength. In accordance with some embodiments, the knurling wheel may be composite and/or have knurling surfaces that have different or the same face angles relative to a radial reference line. The knurling wheels of the present disclosure may be made by traditional machining processes or by additive manufacturing and may be used to provide small indentations (knurls) along the length of a thermal break pocket on an architectural frame extrusion. These knurls may be produced on both the interior and exterior extrusions. The thermal break is then inserted and the pocket is crimped inward against the thermal break, i.e., a bead formed on an edge thereof. During this process, the thermal break material extrudes into the knurls providing strength and integrity to the architectural frame. Aspects of the present disclosure are directed to increasing the strength of the conjunction of the thermal break and the attached extrusion and to the overall architectural assembly.

FIG. 1 shows a composite member 10 having first and second metal extrusions 12, 14, e.g., made from an aluminum alloy connected by a thermal break 16, e.g., made from polyamide or nylon. The thermal break 16 has a first portion 18 and a second portion 20, which may be structurally connected or independent elements. Each of the first portion 18 and the second portion 20 has a bead 22 at either end that is received in a slot 24 in each of the first and second metal extrusions 12, 14. Prior to crimping, the beads 22 may slide/telescope in the slots 24. After crimping, the crimped slot 24 clamps down on the beads 22 of the thermal break 16, rigidly attaching the first and second metal extrusions 12, 14 to the thermal break 16. If selected surfaces of the slots 24 in the metal extrusions 12, 14 are knurled before crimping, the knurled surfaces “bite into”/inter-digitate with the thermal break 16, which is displaced by the high points/teeth of the knurled surface and extrudes/plastically deforms/flows into the low areas of the imparted knurled pattern in the extrusions 12, 14. The inter-digitation of the knurled extrusions 12, 14 with the thermal break 16 suppresses relative translational motion, promoting structural integrity and rigidity in the resultant composite member 10.

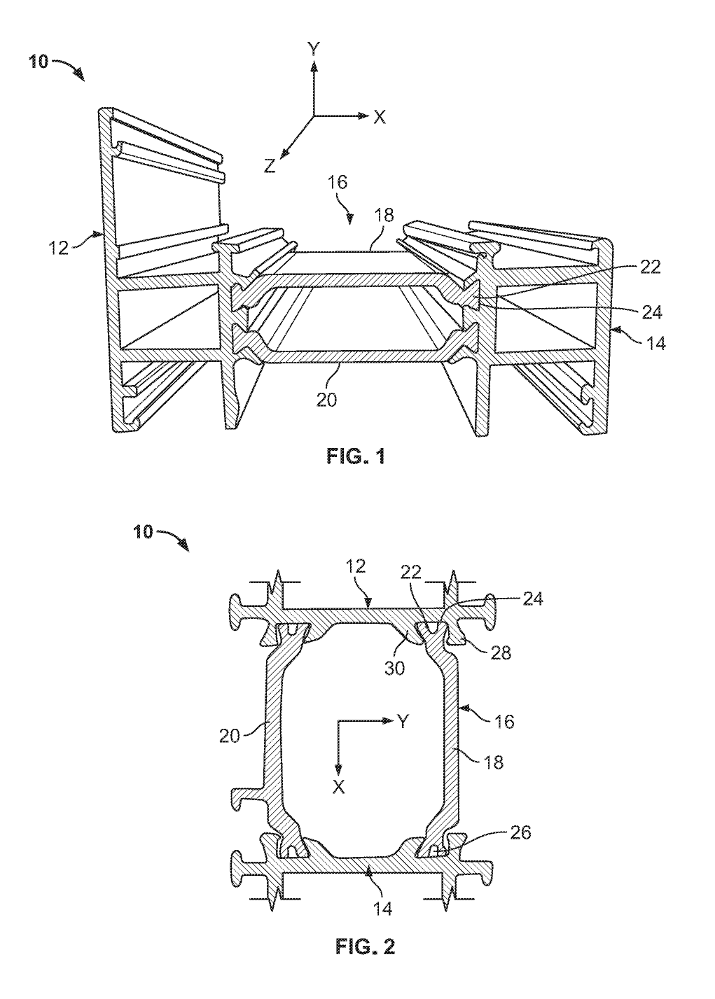

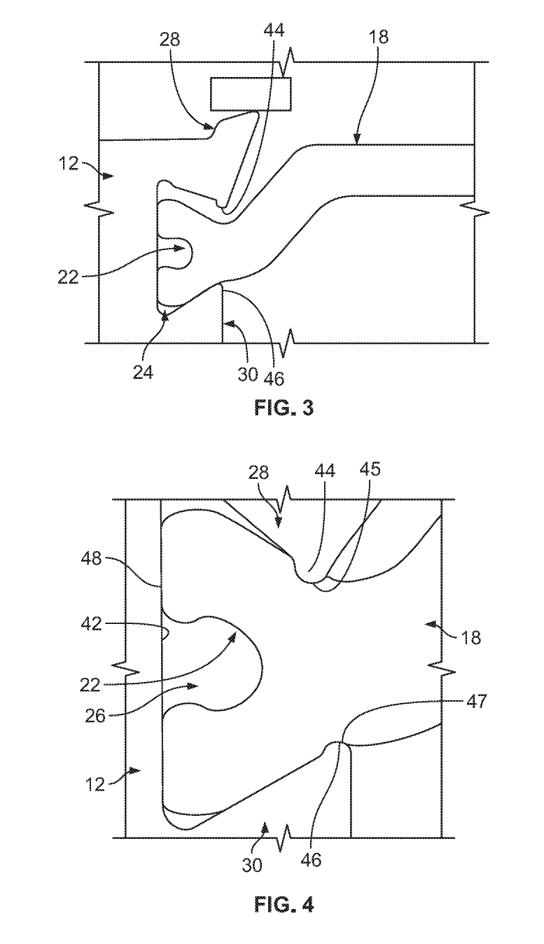

As shown in FIGS. 1-4, the slots 24 have opposed “hammer” portions 28 (the portions that move when crimping occurs) and “anvil” portions 30 (the portion that doesn't move substantially on crimping). The thermal break 16 is attached to the extrusions 12, 14 by pressing the hammer portions 28 towards the adjacent anvil portions 30, pinching the corresponding bead 22 of the thermal break 16 there between. As shown more clearly in FIGS. 3 and 4, the bead 22 may have a groove 26. An adhesive may optionally be applied to the bead 22, e.g., as a stripe of adhesive inside the groove 26 or on another surface of the bead 22. A stiffening cord (not shown) may also be inserted into the groove 26 to render the bead 22 more resistant to compression. FIG. 3 shows a grooved bead 22 of the first portion 18 of the thermal break 16 inserted in the slot 24, resting against the tip 46 of the anvil 30 and with a spacing between the bead 22 and the tip 44 of the hammer 28, prior to crimping. The tips 44, 46 of the hammer 28 and anvil 30, respectively, protrude to provide a local surface area of contact and a concentration of force that promotes the local deformation of the bead 22, forming deformation recesses 45, 47 upon crimping. FIG. 4 shows the position of the hammer 28 after crimping, more particularly, tip 44 of the hammer 28 is pressed into the bead 22. Since the thermal break is formed of a polymer, such as polyamide, it deforms to accommodate the tip 44 in an indented recess 45. Opposite to the hammer 28, the tip 46 of the anvil 30 is also pressed into the outer surface of bead 22 in indentation recess 47. The crimping process forces a face 48 of the bead 22 against a back wall 42 establishing a frictional engagement therewith. In this manner, the bead 22 is firmly captured in the slot 24, retaining the first portion 18 of the thermal break 16 in association with the first extrusion 12, in frictional engagement therewith at the face 48 and indentation recesses 45 and 47. Because the composite member 10 (FIGS. 1 and 2) utilizing the extrusions 12, 14 and the thermal breaks 18, 20 is subject to significant forces, including shear forces, and must retain its shape and load-bearing contact under these forces, it is beneficial to increase the grip of the hammer 28 and anvil 30 on the bead 22 by knurling the hammer and anvil tips 44 and 46.

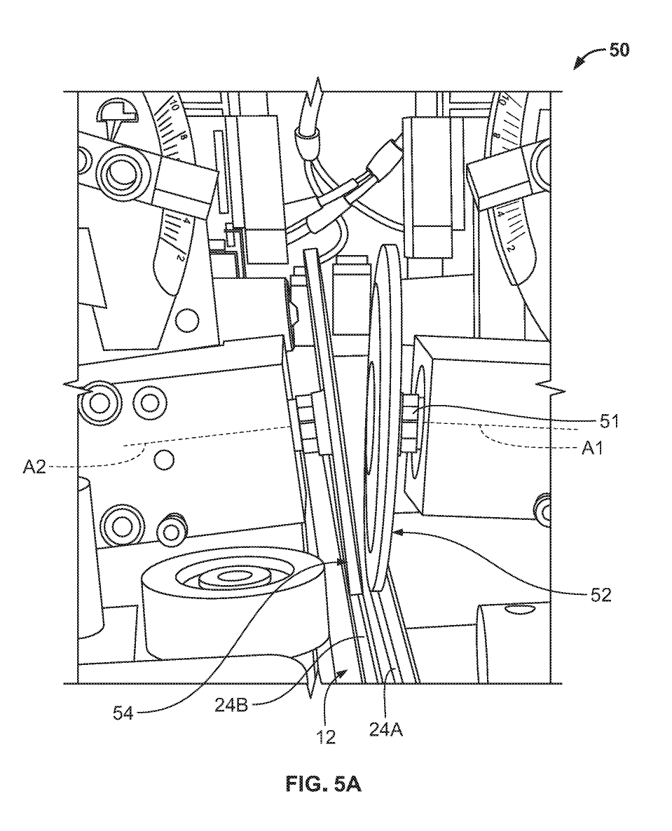

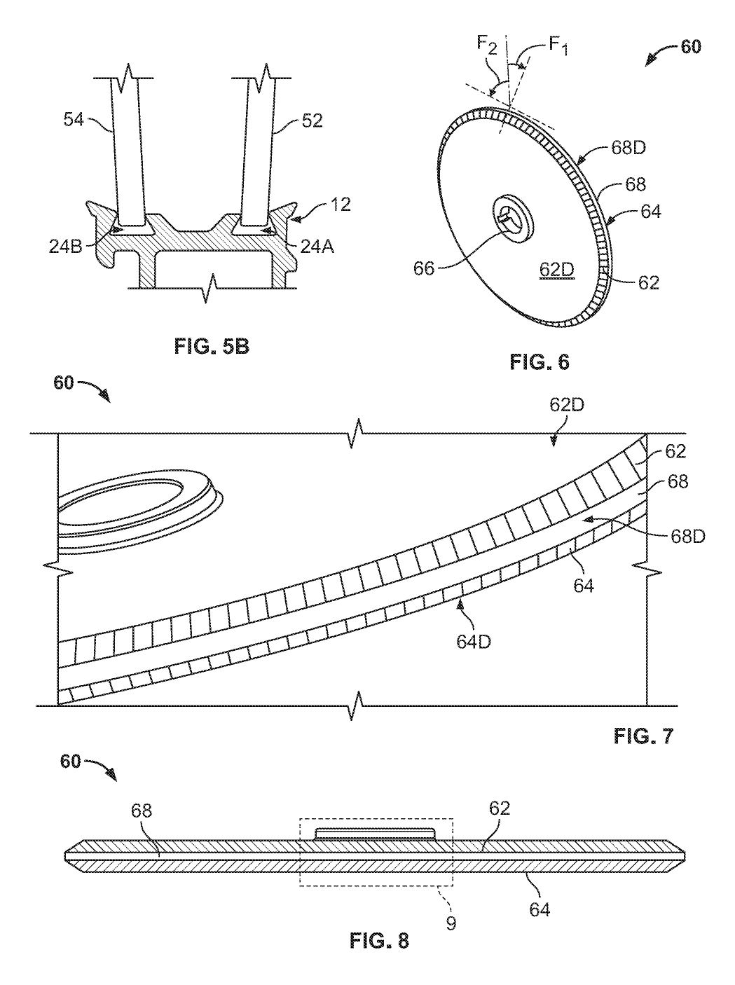

FIG. 5 shows a knurling apparatus 50 having first and second knurling wheels 52, 54 with angularly offset axes of rotation A1, A2. The knurling wheels 52, 54 are pressed into first and second slots 24A, 24B of a metal extrusion 12. The knurling wheels 52, 54 have grooved knurling surfaces 62, 64 (see FIGS. 6 and 7) that impart a knurling pattern in the area of the slots 24A, 24B on the extrusion 12. As can be seen, knurling wheels 52, 54 are angularly offset, e.g., by about 10 to 15 degrees. An aspect of the present disclosure is the recognition that the angle of attack of the knurling wheel and the knurling surfaces relative to the slot, e.g., 24A, correlates to a specific knurling pattern and area that is knurled in the area of the slots, 24A, 24B and further, that the knurling applied to a hammer tip 44 (FIG. 3) may be made at a first angle of attack and the knurling of an anvil tip 46 (FIG. 3) may be at another angle of attack, each being chosen to improve the interaction of the knurled surface with the thermal break 16 (18, 20) upon crimping.

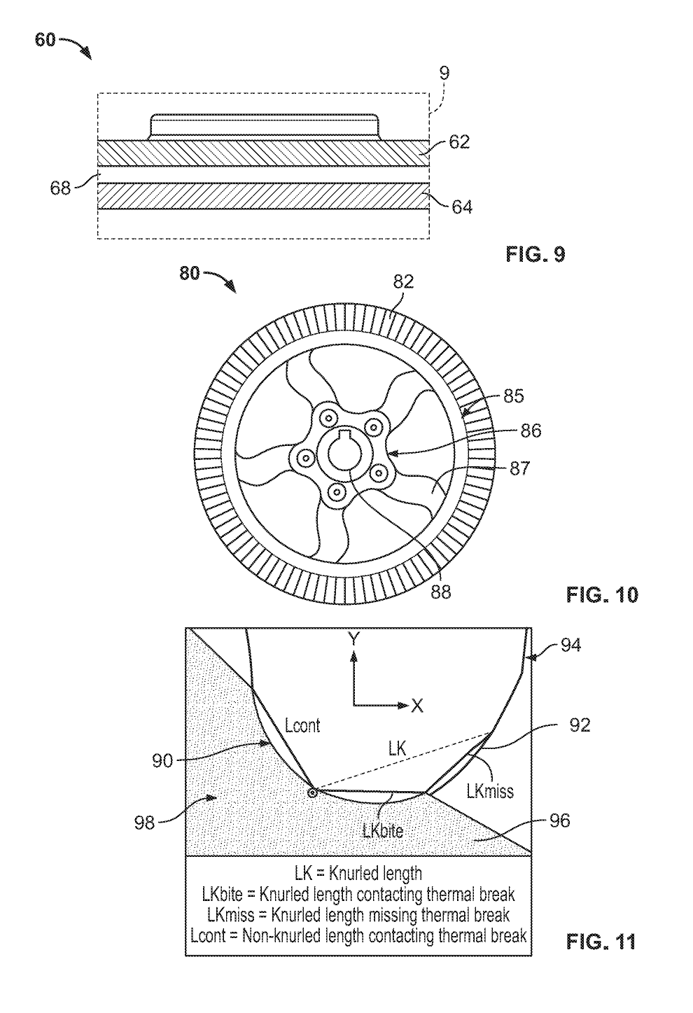

FIG. 6 shows a knurling wheel 60 in accordance with an embodiment of the present disclosure and having a first grooved surface 62 and a second grooved surface 64 disposed at face angles F1, F2 relative to a radial orientation (opposite angles being shown for ease of illustration). An arbor hole 66 allows the knurling wheel 60 to be fitted to an arbor of a knurling apparatus 50, as shown in FIG. 5. FIGS. 6-9 show that in one embodiment, the knurling wheel 60 can be formed as a laminate structure (stack) of a plurality of independent disks (solids of rotation) 62D, 64D, 68D, which can be assembled into a single knurling wheel 60. The first grooved surface 62 and the second grooved surface 64 may be formed on the outer peripheral edges of corresponding disks 62D, 64D, which are then assembled with an intermediate spacer disk 68D with outer surface 68 to form a laminate knurling wheel 60. In one embodiment, the disks 62D, 64D and 68D may be adhered together, e.g., by adhesive and may utilize mating registration features, such as mating pins and recesses, to aid in preventing independent rotation when knurling is conducted. Alternatively, the disks 62D, 64D and 68D may be held in relative juxtaposition by a nut (not shown) which holds them on an arbor 51 of the knurling machine 50 (FIG. 5). Spacer disks 68D of different thicknesses may be selectively grouped with the disks 62D, 64D to form a composite knurling wheel 60 having a variety of thicknesses which are appropriate for knurling different extrusions 12 with different sized slots 24. Instead of three disks 62D, 64D, 68D, a pair of disks 62D, 64D could be utilized having a given integral spacer thickness extending toward the other of the disks 62D, 64D. In another alternative, more than three disks 62D, 64D, 68D, could be employed. The face angles F1, F2 and/or knurling patterns on the first and second grooved surfaces 62, 64 of the knurling wheel 60 may be the same or different, depending upon the application. The teachings of the present disclosure may permit a reduction in knurling wheel inventory by eliminating the need for multiple wheels for multiple extrusions and potentially longer knurl wheel life because as one radial knurling surface of contact (band) of the wheel 60 wears, a different radial band could be positioned to contact the extrusion by using a different spacer/shim 68D thickness. Knurling wheel spacers/shims 68D can also be used to adjust to different coating thicknesses, e.g., attributable to painted coatings and anodization. A given wheel 60 can provide more or less knurling engagement depending upon wheel 60 thickness, which can be used to adjust to additional extrusion thickness (from paint) or lesser extrusion thickness (from anodizing).

FIG. 10 shows a knurling wheel 80 in accordance with another embodiment of the present disclosure, which is formed by 3D printing techniques (additive manufacturing techniques), such as: DMLS (Direct Metal Laser Sintering) and may be made from various materials, such as Ni-based alloys, titanium alloys or steel. Knurling wheel 80 features an external ring 85 supporting first and second grooved surfaces 82, 84 (84 not visible in this view, on the back side of wheel 80), which may be machined into the knurling wheel 80 or may be produced by additive processes. The ring 85 is supported by spokes 87 radiating from hub 86 through which a keyed arbor hole 88 extends.

FIG. 11 shows a side view of a crimped indentation interface 90 where the tip 92 of a hammer 94 interacts with a bead 96 of a thermal break 98. Knurling of the tip 92 results in peaks and valleys in the tip 92. The extent of knurling coverage is depicted by line LK, which approximates the impression width made by the peaks of the grooved surface, e.g., 72 of the knurling wheel, e.g., 70. The portion of the knurling impression in contact with the thermal break is shown by the line segment LK_{bite}. The portion of the knurled tip 92, e.g., as shown by LK, that does not contact or interdigitate with the bead 96 when crimped is shown by line segment LKₘᵢₛₛ. The un-knurled portion of the tip 92 that contacts the thermal break 98 and makes an impression therein is represented by L_{cont}. The cross-sectional area bounded by L_{cont} and the tip surface extending between the endpoints of L_{cont} represents the cross-sectional area of the impression made in the thermal break by the non-knurled portion of the tip 92. As can be appreciated, the portion of LK which bites into the thermal break is dependent upon the final angular orientation of the tip 92 relative to the thermal break 98 after rotation from crimping, the beginning orientation of the line LK relative to the tip length direction, and the degrees of rotation traversed when crimping occurs. An aspect of the present disclosure is the recognition of this relationship and the design and use of the knurling wheel to reconcile these factors to improve knurling bite by getting more of the knurled region (LK_{bite}) of tip 92 in contact with the thermal break 98, thus reducing LKₘᵢₛₛ. An aspect of the present disclosure is the recognition that the movement of the hammer through several degrees of rotation in order to encounter the thermal break 98 as shown in FIG. 11, causes a significant angular reorientation of the knurled surface from the orientation that existed when first knurled (prior to crimping), e.g., as shown by LK, before and after crimping. The present disclosure therefore considers this change in position of the knurling pattern attributable to crimping and proposes optimizing the portion of the tip 94 that is knurled. It should be appreciated that the anvil tip 126 (FIGS. 14 and 16) does not move substantially, such that the portion of the anvil tip 126 that is optimally knurled may be different than the portion of the hammer tip 94.

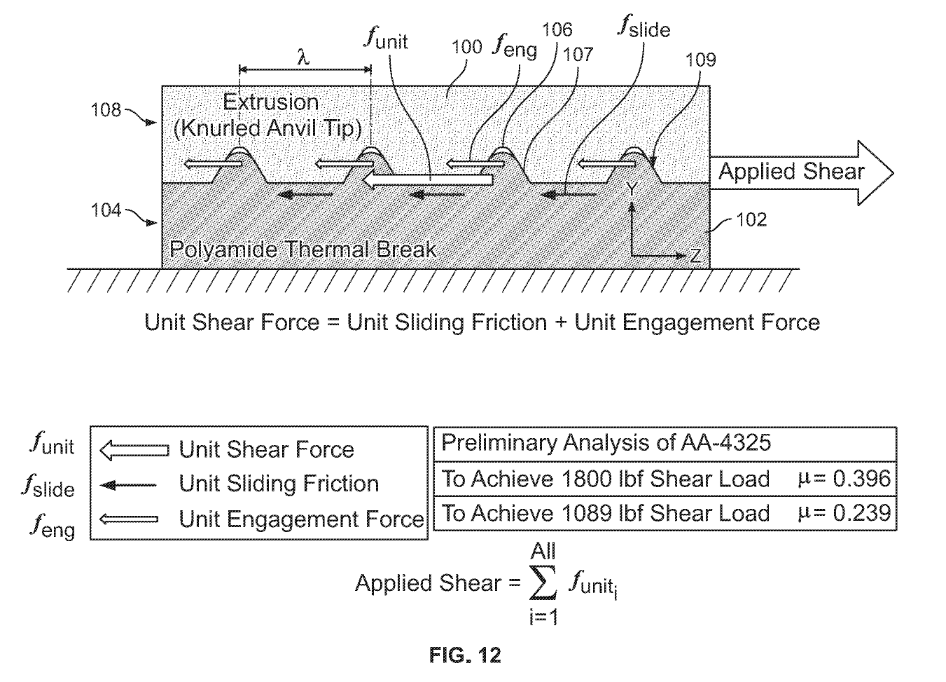

FIG. 12 shows the interface between the anvil tip 100 and a bead 102 of a thermal break 104, at a viewing perspective 90 degrees offset from the viewing perspective shown in FIG. 11. When crimping occurs, the deformable plastic thermal break 104 extrudes into the knurl depressions 106 formed in the tip 100 by a knurling wheel, e.g., 60. More particularly, the peaks of the grooved surface, e.g., 62 of the knurling wheel 60 form a pattern of depressions 106 in the metal extrusion 108 (on the tip of the anvil 100 and on the tip of the hammer when it is knurled) having a spacing (wavelength) λ. When the knurled extrusion 108 is pressed against the softer thermal break 104 during crimping, the thermal break 104 extrudes into the knurl depressions 106 providing a mechanical inter-digitation/keying and increasing the surface area of contact of the respective elements, such that an applied shear force would have to overcome the frictional force along the interface 109 and shear the extruded portions 107 of the thermal break 104 or ride up the extruded portions 107 (reversing the crimp and forcing the anvil tip 100 away from the bead 102 of the thermal break 104 to a degree) in order to move in translation relative to the thermal break 104. FIG. 12 illustrates the forces resisting shear as a unit shear force fᵤₙᵢₜ having a unit engagement force component f_{eng} and a unit sliding friction component f_{slide}. An aspect of the present disclosure is the recognition that a particular level of friction need be achieved to support the target shear loads. From theoretical calculations, a friction coefficient μ of 0.239 is required to support an average shear load of 1084 lbf (for a 4 inch test section) while friction coefficient μ of 0.396 is required to support a shear load of 1800 lbf.

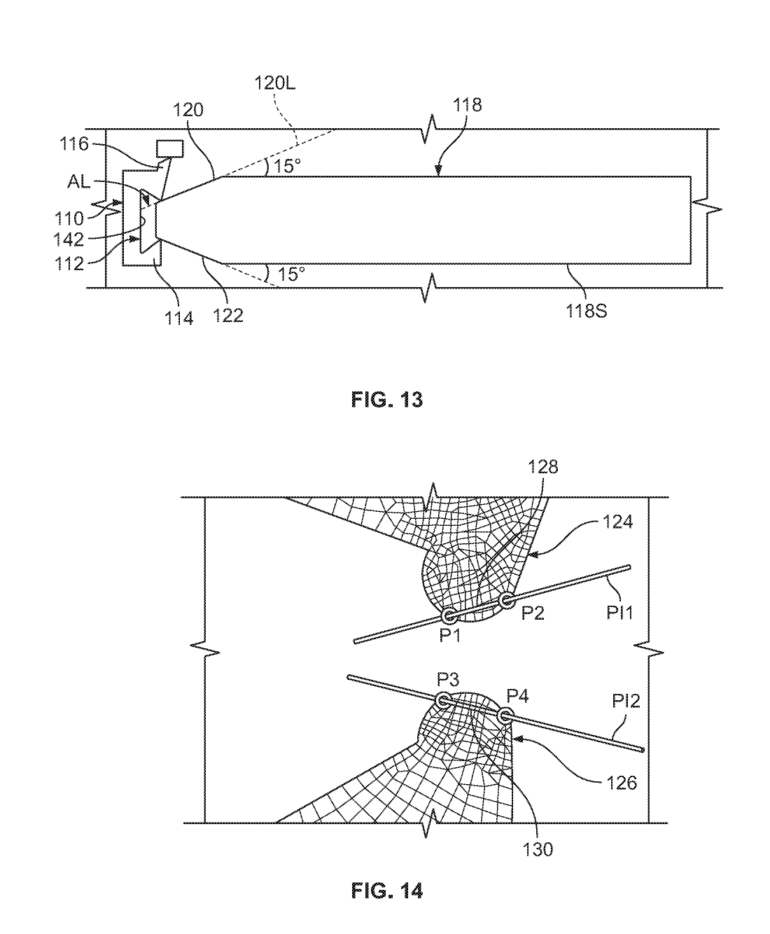

FIG. 13 shows an extrusion 110 with a slot 112, hammer 116 and anvil 114 which are being knurled by a knurling wheel 118. The knurling wheel 118 has first and second grooved surfaces 120, 122 that have a 15 degree angle relative to the sides 118S of the wheel. If extended to the back wall 142, the dotted line 120L corresponding to the face 120 orientation makes a lesser angle AL of 75° with the back wall 142 (the greater angle—not shown—being 105°.)

FIG. 14 diagrammatically shows the extent of knurl impressions 128, 130 along lines PI1, PI2 that are made on hammer and anvil tips 124, 126 by grooved surfaces 120, 122 of the knurling wheel 118 of FIG. 13. As can be appreciated, the lines PI1, PI2 mimic the angular orientation of the grooved surfaces 120, 122 shown in FIG. 13. The lines PI1, PI2 correspond to the impression made by the peaks of the grooved surfaces 120, 122, which have the greatest impression depth in the hammer and the anvil tips 124, 126. FIG. 14 depicts a state prior to crimping.

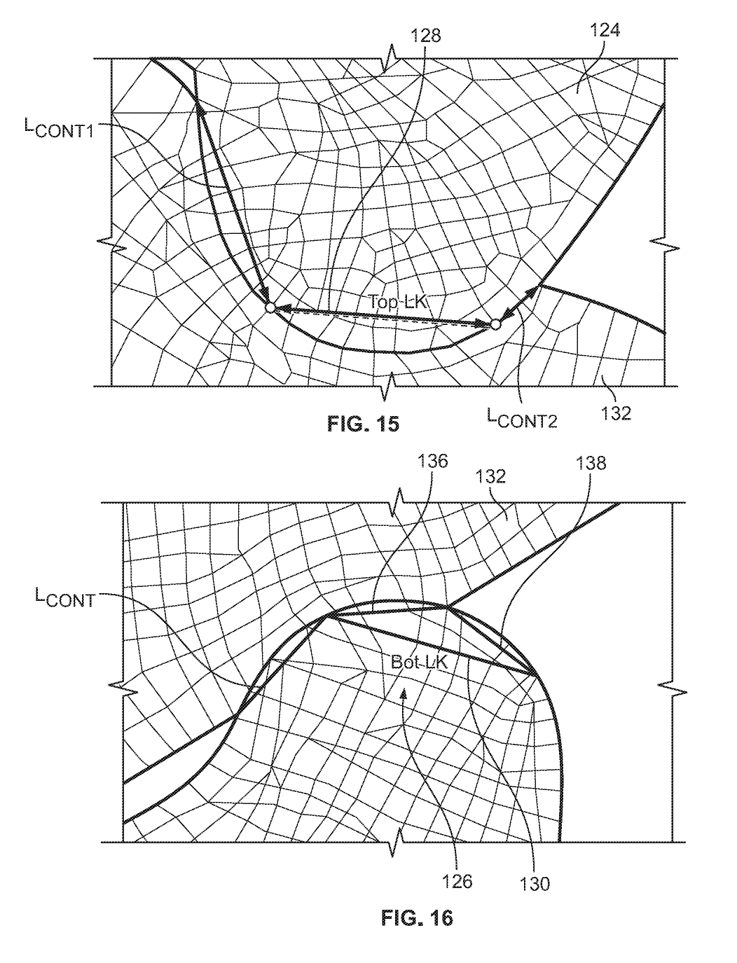

FIGS. 15 and 16 illustrate the post-knurl, post-crimp state, with FIG. 15 showing the hammer tip 124 pressed into the thermal break 132 and FIG. 16 showing the anvil tip 126 pressed into the thermal break 132. As in FIG. 14, the length of the knurl peak impression 128 is labelled as line Top LK. The non-knurled lengths of the hammer tip 124 contacting the thermal break 132 are labeled L_{CONT1} and L_{CONT2}. Since the entire length of 128 (Top LK) contacts (is impressed into the thermal break 132, the extent of the knurling pattern has been applied efficiently to improve the shear strength at the interface of the hammer tip 124 and the thermal break 132. Further, it can be concluded that the initial orientation of the hammer tip 124 and the knurling wheel 118 (FIG. 13), as well as the face angle (15°) of the grooved surface 120 were appropriate for generating a knurling pattern with knurl peak impressions 128 as shown in FIG. 14, that when rotated into a crimped position will effectively extrude/inter-digitate with the thermal break 132. In one example from a representative set of eight unique architectural frames, the extent of crimping can be varied, e.g., from between a heavy, medium and light crimp, with a heavy crimp generating a crimp depth of about 0.056 inch of the knurled surface peaks into the beads of the thermal break, a medium crimp generating a crimp depth of about 0.046 inch, and a light crimp generating a crimp depth of about 0.039 inch. In another example, a heavy crimp would have a crimp depth>0.052 inch, a medium crimp between 0.037 inch and 0.052 inch and a light crimp<0.037 inch in depth.

FIG. 16 illustrates the length of the knurl peak impression 130 in the anvil tip 126. The non-knurled length of the anvil tip 126 contacting the thermal break 132 is labeled L_{CONT}. Only a portion 136 (LK_{bite}) of the length of 130 (Bot LK) contacts (is impressed into) the thermal break 132 and a portion 138 (LKₘᵢₛₛ) makes no contact with the thermal break 132. An aspect of the present disclosure is the recognition of this condition, that the condition is not optimal and can be improved by knurling the anvil tip 126 at a different location by a knurling wheel, e.g., 60, either held at a different angle of attack relative to the anvil tip 126 or having knurling surfaces, e.g., 62, 64 of the knurling wheel 60 disposed at different face angles for knurling the anvil tip 126 compared to that used for knurling the hammer tip 124. Another aspect of the present disclosure is the recognition that the angle at which knurling of the either the anvil tip 126 or the hammer tip 124 takes place is a factor in the magnitude of inter-digitation that occurs upon crimping. As a result, selection of the area of the anvil tip 126 and the hammer tip 124 and the angle of knurling along with the local orientation of the thermal break surface plays a role in the effectiveness of knurling and in increasing shear strength. In addition, the effect of movement of the hammer tip 124 and/or anvil tip 126 and the resultant reorientation of the knurling pattern 128, 130 due to crimping should be taken into consideration.

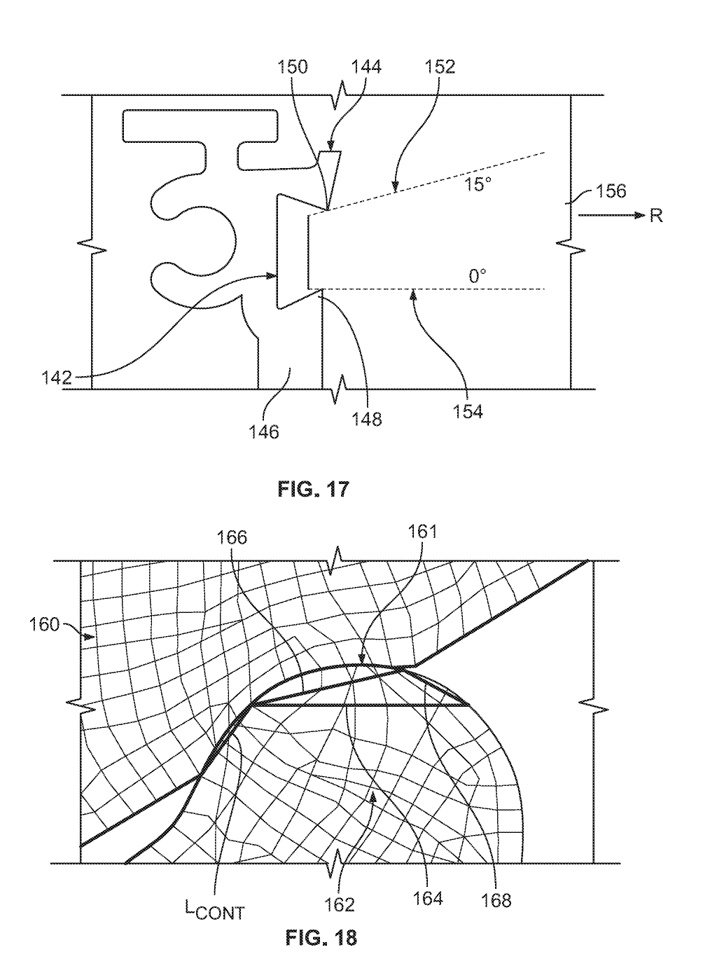

FIG. 17 shows an alternative knurling approach and apparatus to that shown in FIG. 13, wherein knurling wheel 156 has a first grooved knurling surface 152 at a 15 degree angle relative to a radial direction for knurling the hammer tip 150 and a second grooved knurling surface 154 that is at a 0 degree angle relative to the radial direction for knurling the anvil tip 148.

FIG. 18 shows the interface 161 between the anvil tip 162 and the thermal break 160 after crimping. The knurl extent 164 (Bot LK) attributable to knurling with the 0 degree knurled surface 154 of FIG. 17 has a portion 166 (LK_{bite}) that bites or inter-digitates with the thermal break 160 after crimping. A portion 168 (LKₘᵢₛₛ) of the knurl peak impression 164 misses the thermal break 160 upon crimping. Upon comparing the lengths of 166 (LK_{bite}) and 168 (LKₘᵢₛₛ) in FIG. 18 to the lengths of 136 (LK_{bite}) and 138 (LKₘᵢₛₛ) in FIG. 16, one can see that the 0 degree knurling approach produced a greater length of biting and less missing at the interface of the anvil tip 162 and the thermal break 160 than the 15 degree knurling approach used in forming the interface shown in FIG. 16. The non-knurled portion in contact (L_{CONT}) with the thermal break 160 is also smaller than in FIG. 16.

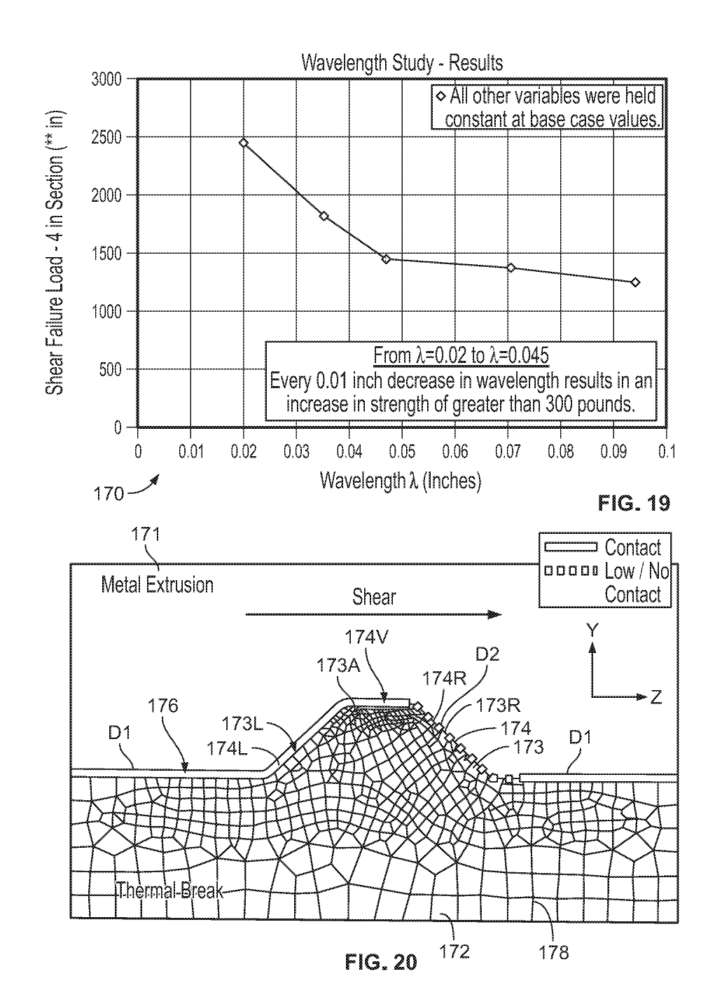

FIG. 19 illustrates another aspect of the present disclosure obtained by finite-element analysis, viz., the recognition that decreasing the wavelength λ of the peaks on grooved surface, e.g., 62, 64 on the knurling wheel, e.g., 60 (increasing the number of peaks and decreasing the distance between them, all other variables, such as peak height and width at the base remaining the same, and hence on the knurled extrusion, 108 (FIG. 12),) below that which is typically encountered, e.g., 0.040 inch, results in an increase in strength. More particularly, for wavelengths λ from 0.02 to 0.045 inch every 0.01 inch decrease in wavelength λ corresponds to an increase in strength of greater than 300 pounds. FIG. 12 also illustrates the corresponding wavelength λ generated in the knurled extrusion.

FIG. 20 graphically shows the results of a finite-element analysis of shear force pushing in the longitudinal extrusion direction (Z) exerted by a metal extrusion 171 on a thermal break 172 pushed relative thereto in a shear direction (with the thermal break 172 either pushed in the opposite direction or held in a stationary position). As can be appreciated, an extruded portion 173 of the thermal break extends into a knurl recess 174, e.g., as a consequence of having crimped a knurled metal extrusion 171 about a polyamide thermal break 172, as described above. When subjected to shear, either in the form of a force applied to the metal extrusion 171 or a lateral displacement of the metal extrusion 171 of a given magnitude relative to the thermal break 172, the contact between the extruded portion 173 and the recess 174 changes responsively. Contact between the extrusion 171 and the thermal break 172 is represented in FIG. 20 by a thick solid line D1 along the interface 176. A high level of contact is observable between the apex 173A of the extruded portion 173 of the thermal break 172 and the valley 174V of the recess 174 of the metal extrusion 171, e.g., due to the forces of crimping. Under shear stress, as shown, the contact between the left side 174L of the recess 174 and the left side 173L of the extruded portion 173 is maintained and contact between the right side 174R of the recess 174 and the right side 173R of the extruded portion 173 diminishes, as represented by the thick dashed line D2. The mesh 178 is more finely partitioned closer to the interface 176 and in the area of the apex 173A of the thermal break 172 in order to enhance the precision of the analysis in these areas.

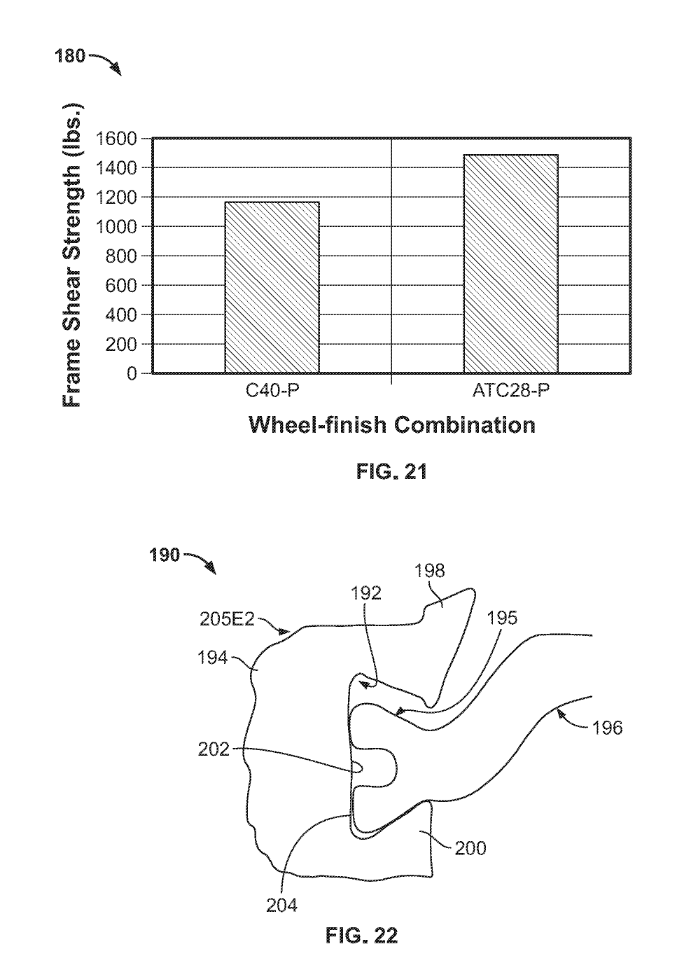

FIG. 21 shows a graph 180 that illustrates experimental results consistent with FIG. 19 in the context of comparing resultant frame shear strength for a frame with extrusions knurled with a 0.040 inch wavelength knurling wheel (C40-P) compared to knurling the same frame with a knurling wheel ATC 28-P with a pitch of 0.028 inch. The graph 180 shows the comparison of frame strength of identical frame members made as a composite of knurled metal extrusions crimped to grasp a polyamide thermal break, the only difference being the wavelength of the knurling pattern on the extrusions imparted by knurling wheels C40-P and ATC28-P. Typically, frame strength is tested via shear tests on 4-inch sections of a given frame sample. As can be appreciated, the smaller wavelength knurling pattern results in a significant increase in frame strength on the order of 25%.

In other testing on a given frame geometry, the comparative strengths for anodized extrusions with different knurling wavelengths, i.e., 0.040 inches vs. 0.028 inches, for each of three crimp strengths (heavy, medium and light) was measured. The 0.028″ knurled frames exhibited significant increases in shear strength compared to the 0.040″ knurled frames. More particularly, for the 0.040″ frames: heavy: 1160 lbs., medium: 810 lbs., and light: 260 lbs. In contrast, the 0.028″ knurled frames exhibited shear strengths: heavy: 1430 lbs, medium: 1060 lbs and light: 410 lbs. Notably, the comparison of heavy crimped frames showed a shear strength increase of about 24% for 0.028″ vs. 0.040″ knurling wavelengths, all other factors remaining the same.

In another series of tests with a painted extrusion finish, the 0.040″ knurling produced shear strength values for heavy crimping of 1160 lbs. compared to 1470 lbs. for the 0.028″ pitch knurled frame with a heavy crimp, or about a 27% increase in frame shear strength for the 0.028″ pitch knurling. The use of 0.028″ knurling pitch resulted in shear strengths in excess of 1,000 lbs. for each of heavy, medium and light crimping. For additively manufactured knurling wheels, it was experimentally determined that frame shear strength increased with reductions in knurling pitch from 0.040″ to 0.020″. For heavy crimped frames, the testing showed a shear strength of 840 lbs for 0.040″ pitch knurling, 1,000 lbs. for 0.028″ and 1110 lbs. for 0.020″ wavelengths. It is therefore expected that decreases in knurling pitch will generate similar strength increases in frames knurled with 0.020″ machined knurling wheels.

FIG. 22 shows a slotted bead 195 of a thermal break 196 extending into a slot 192 of an extrusion 194 prior to the crimping. On crimping, the hammer 198 will press the bead 195 against the anvil 200 and grip it in that position owing to deformation of the hammer 198. In addition, the rotation of the hammer 198 will push the face 204 of the bead 195 against a back wall 202 of the slot 192. The contact between the face 204 of the bead 195 and the back wall 202 of the slot 192 represents another source of frictional interaction between the thermal break 196 and the extrusion 194, increasing shear strength of the conjunction/composite member, e.g., 10 of FIG. 1. An aspect of the present disclosure is the recognition that the back wall 202 of the slot 192 can be roughened through various means to increase the frictional interaction with the face 204 of the bead 195 and/or to establish keying/inter-digitation therewith. In one approach, the back wall 202 may be roughened by extrusion tearing when the extrusion 194 is formed/extruded. In another approach, the back wall 202 may be knurled by the outer diameter of a knurling wheel, e.g., 60 that has grooves on the outer peripheral surface, e.g., referring to FIG. 7, on the outer surface of the intermediate spacer 68D, which may be pressed against the back wall 202 when knurling is conducted. Another surface modification approach is to extrude longitudinal serrations into the back wall 202 to increase the contact surface area and increase the propensity for surface tearing that could act like a knurled surface. Alternatively, a thin knurling wheel with a knurling pattern on the outside periphery that is designed to clear the hammer and anvil of the slot, may be used to knurl the back wall 202 in a separate step.

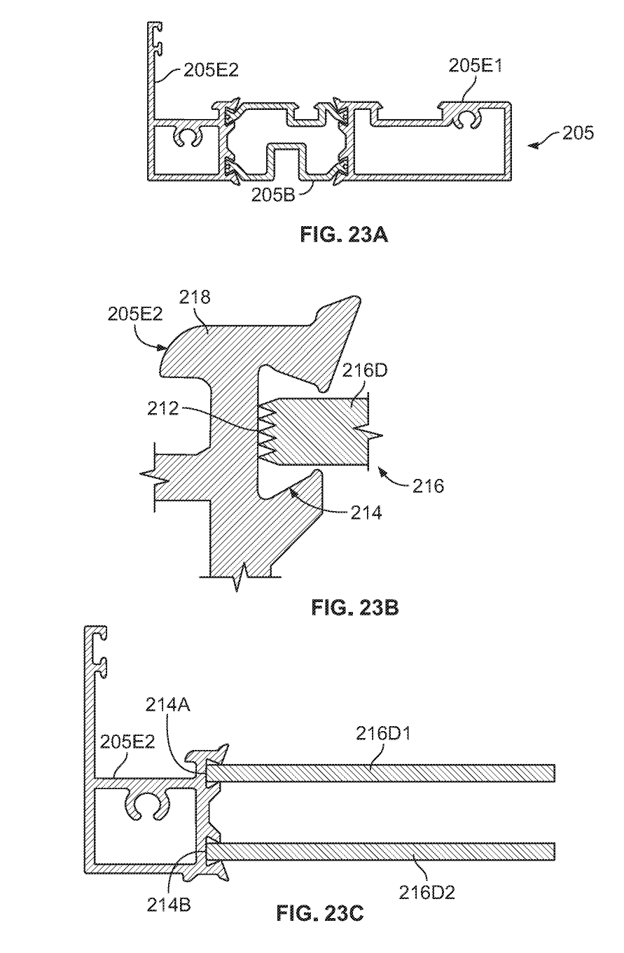

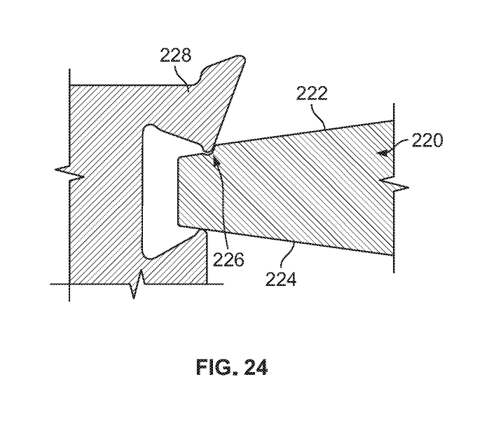

FIG. 23A shows a composite member 205 having metal extrusions 205E1, 205E2 bridged by a thermal break 205B.

FIG. 23B shows a spark discharge apparatus 216 with a disk 216D held at a high electrical potential relative to the extrusion 218 and that may be inserted into a slot 214 of an extrusion 218 and rolled along the back wall 212 to roughen it. An electrical discharge or arc between the disk 216D and the back wall 212 locally melts the back wall where the arc occurs, creating a pit. This pitting can be conducted along the entire surface of the back wall to increase frictional interaction between the back wall 212 and a bead of a thermal break that is inserted in the slot 214 and crimped in place. Unlike a process of texturing/knurling the back wall 212 by a knurling wheel, the arcing process does not require force to create pitting, so arcing would not distort the extrusion to the same extent as knurling with a knurling wheel. In another alternative, a small welding head may be used to deposit material on the back wall 212 to impart a roughened topography. As a further alternative, the discharge electrodes could be incorporated into a knurling wheel to allow accomplishing the texturing of the back wall and the anvil and hammer tips simultaneously. FIG. 23 shows dual electrode wheels 216D1, 216D2 roughening two slots 214A, 214B, simultaneously.

FIG. 24 shows an approach to further increase the knurled contact area by a modification to the contour of a knurling wheel. In this approach, a knurling wheel 220 with top surface 222 and bottom surface 224 has its top surface contoured with a step feature 226 that conforms to hammer tip 228. This knurled contour imparts a larger knurled region LK to the hammer tip increasing the potential bite region LK_{bite}. This could be advantageous for instances where a large crimp distance is necessary because it potentially rotates more knurled surface into contact with the thermal break. Given how small the step feature could be, this could be a candidate for construction by additive manufacturing if conventional machining options are inadequate at making a contoured knurled surface. This step feature could be applied to bottom surface 224 if the post-crimp geometry of the thermal break would contact that region.

The present disclosure recognizes that the frame strength of composite architectural structures like windows and doors is dependent on the characteristics and dimensions of the knurls which are formed in the metal extrusions thereof by a knurling wheel. In addition, a thermal break may be coated with a tie-layer material and/or adhesives on the regions touching the extrusions, the anvil and hammer tips, and/or any unknurled regions including the back wall 202 of extrusion slot 214 to improve the strength of the frame. Another aspect of the present disclosure is a composite architectural frame section with multiple subcomponents providing mechanical strength and thermal isolation, joined by crimping together an interface with the harder side (e.g. metal extrusion) knurled to receive the softer side (e.g. polymer thermal break) providing shear strength at the interface.

The knurled surface may be produced with a knurling wheel that has an optimal spacing and/or wavelength of the knurling pattern providing a maximum shear strength. the optimal spacing and/or wavelength being at least partially dependent on the geometry of the unit indentation imparted by the knurling wheel and any flat, absence of flat, or interference between the indentations. The knurling wheel may be monolithic or constructed of subcomponents. The subcomponents permit variations of the knurling wheel design including: overall wheel thickness; side-to-side customizable face angles appropriate for a given extrusion geometry; and the ability to use alternative manufacturing methods such as additive manufacturing.

A knurling wheel in accordance with the present application with subcomponents may provide logistical advantages including at least one of: reduced wheel inventory; longer wheel life; the ability to assemble wheels from subcomponents produced by different manufacturing methods; and the ability to directly compare wheel teeth from different manufacturing methods on the same extrusion. In accordance with an aspect of the present disclosure, the metal extrusion subcomponent has features (hammer tip and anvil tip) that receive the knurling pattern. The as-crimped orientation of that knurled pattern on the tips contacts the softer thermal break subcomponent in such a way that most to all of the knurled pattern is in mechanical contact with the softer thermal break subcomponent providing shear resistance. The geometry of the softer thermal break subcomponent may also be selected to assure that most to all of the knurled pattern on the harder metal extrusion subcomponent is in mechanical contact with the softer thermal break subcomponent when crimped.

In accordance with another aspect, the knurled surface can be applied to other surfaces of the harder subcomponent that contact the softer subcomponent. In this way an engineered crimping operation can drive together these additional surfaces to provide additional contact area and increased friction for additional shear resistance. The knurled surface can be formed by at least one of: electrostatic discharge, surface crevice features formed during the manufacture of the harder metal extrusion subcomponent (for example, localized surface checking during extrusion or the extrusion of serrated topographies), sputtered metal, adhesive application, or other processes that alter the surface topography of the harder metal extrusion subcomponent where it contacts the softer thermal break subcomponent.

The teachings of the present disclosure may be used to achieve increased shear strength of a frame to improve existing products and offer them for new applications, the development of new products based upon increased strength, and a reduction in scrapped frames due to not meeting strength requirements or to over-crimping in order to meet strength requirements.

It will be understood that the embodiments described herein are merely exemplary and that a person skilled in the art may make many variations and modifications without departing from the spirit and scope of the disclosed subject matter. All such variations and modifications are intended to be included within the scope of the claims.

1. A composite member, comprising:
an interior metal extrusion with a first recess therein extending along at least a portion of a length thereof;
an exterior metal extrusion with a second recess therein extending along at least a portion of a length thereof;
a thermal break with a thermal conductivity lower than a thermal conductivity of the interior metal extrusion and the exterior metal extrusion inserted there between and connected thereto; the thermal break having a plurality of beads extending along at least a portion of a length thereof, a first bead of the plurality of beads extending into the first recess and a second bead of the plurality of beads extending into the second recess, the interior and the exterior extrusions crimped proximate the first recess and the second recess, respectively, to hold the first bead and the second bead therein, respectively, the first recess and the second recess being knurled therein along at least a portion of a length thereof in a knurl pattern of peaks and valleys having a wavelength<0.040 inches, the peaks impressing at least partially into the first bead and the second bead.

2. The composite member of claim 1, wherein the first recess and the second recess each have a hammer portion and an anvil portion extending away from a back wall and a pre-crimped state with a first spacing between the hammer portion and the anvil portion, and a post-crimped state with a second spacing less than a width of the first spacing, the hammer portion of each of the first recess and the second recess moving proximate to the anvil portion when transitioning from the pre-crimped state to the post-crimped state and moving through a transition angle, the anvil portion remaining stationary relative to the hammer portion, the knurling pattern applied to a surface of the hammer at a first orientation relative to the back wall when in the pre-crimped state, such that the knurling pattern on the hammer portions of the first recess and second recess, respectively, contact the first bead and the second bead, respectively, in the post-crimped state after moving through the transition angle.

3. The composite member of claim 2, wherein the knurling pattern is applied to the anvil portions at a second orientation such that the knurling pattern on the anvil contacts the first bead and the second bead, respectively, in the post-crimped state after remaining stationary while the hammer portion moved through the transition angle.

4. The composite member of claim 3, wherein the first orientation and the second orientation are different.

5. The composite member of claim 3 where in the first orientation and the second orientation are each 75° relative to the back wall.

6. The composite member of claim 4 wherein the first orientation is 75° relative to the back wall and the second orientation is 90° relative to the back wall.

7. The composite member of claim 1, wherein the wavelength is between 0.020 and 0.040 inches.

8. The composite member of claim 7, wherein the wavelength is 0.028 inches.

9. The composite member of claim 1, wherein an entire impression length (LK) of the peaks of the knurled pattern of the hammer contacts the bead in which it is impressed when in the post-crimped position.

10. The composite member of claim 1, wherein a portion of an impression length (LK) of the peaks of the knurled pattern of the hammer that contacts the bead in which it is impressed when in the post-crimped position exceeds a portion of the impression length (LK) that does not contact the bead in which it is impressed.

11. The composite member of claim 1, wherein a coefficient of friction between the first extrusion and the thermal break is≥0.23.

12. The composite member of claim 1, wherein a length of 4 inches of the composite member can withstand a shear load>1000 lbs.

13. The composite member of claim 2, wherein the back wall has a surface roughness and the thermal break in the post-crimped state engages the back wall.

14. A method for knurling a recess of a metal extrusion defined by a hammer portion and an anvil portion extending from a back wall, comprising the steps of:
providing a knurling wheel with a knurl pattern of repeating peaks and valleys on a surface thereof proximate a periphery of the knurling wheel, the wavelength between peaks being<0.040 inches;
pressing the knurling wheel against at least one of the hammer portion or the anvil portion and impressing a knurling pattern therein.

15. The method of claim 14, further comprising pressing the knurling wheel against both the hammer portion and the anvil portion to impress a knurling pattern therein.

16. The method of claim 15, wherein the knurling wheel is held at a selected angle relative to the back wall of the metal extrusion during the step of pressing.

17. The method of claim 16, wherein the knurling wheel is held at a first selected angle relative to the back wall when pressing the knurling pattern against the hammer portion and at a second angle relative to the back wall when pressing the knurling pattern against the anvil portion.

18. The method of claim 17, wherein the knurling pattern is pressed against the hammer portion and the anvil portion simultaneously by different faces of the knurling wheel.
